(19) United States
(12) Patent Application Publication
(10) Pub. No.: US 2006/0094807 A1
(43) Pub. Date: May 4, 2006

(54) Injectable moldable thermoplastic compositions

(76) Inventors: George Wyatt Prejean, Orange, TX (US); Stephen P. Musemeche, Orange, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/223,061

(22) Filed: Sep. 9, 2005

Related U.S. Application Data
(60) Provisional application No. 60/608,359, filed on Sep. 9, 2004.

(51) Int. Cl. C08K 3/30

(52) U.S. Cl. 524/423

(57) ABSTRACT

The present invention provides a highly-filled thermoplastic composition comprising a low density polyethylene and a tubular reactor produced ethylene/alkyl (meth)acrylate copolymer. The composition exhibits high tensile strength, high flex modulus, high temperature resistance and high tear strength.

### CROSS REFERENCE TO RELATED APPLICATION

The present application claims priority under 35 U.S.C. § 119 to U.S. Provisional Appln. No. 60/608,359, filed on Sep. 9, 2004, which is incorporated herein by reference in its entirety.

### BACKGROUND OF THE INVENTION

1. Field of the Invention

The present invention relates to thermoplastic compositions. More specifically, this invention relates to injectable moldable grade thermoplastic composition comprising a low density polyethylene and a tubular reactor-produced ethylene/alkyl-acrylate copolymer resin.

2. Description of the Related Art

One or more patents are cited in this description in order to more fully describe the state of the art to which this invention pertains. The entire disclosure of each of these patents and publications is incorporated by reference herein.

There are two basic types of plastic: thermosetting, which cannot be resoftened after being subjected to heat and pressure; and thermoplastic, which can be repeatedly softened and remolded by heat and pressure. When heat and pressure are applied to a thermoplastic binder, the chainlike polymers slide past each other, giving the material plasticity. However, when heat and pressure are initially applied to a thermosetting binder, the molecular chains become cross-linked, thus preventing any slippage if heat and pressure are reapplied. Thermoplastics are utilized in various end-products, including carpet backings, scrim fabrics, and other fabrics for article reinforcement or dimensional stability purposes.

U.S. Pat. No. 4,576,993 describes cross-linked polymeric compositions derived from blends of linear low density ethylene homo- or co-polymers with thermoplastic or elastomeric homo- or co-polymers such as ethylene/acrylic ester copolymers (e.g., ethylene/alkyl acrylate or ethylene/alkyl methacrylate) copolymer and ethylene/vinyl acetate copolymers wherein the weight ratio of the blended polymeric component or components to the linear low density ethylene homo- or copolymer in the composition lies in the range 0 to 20:1. These compositions can contain at least 10 weight percent filler, either reinforcing fillers or non-reinforcing fillers.

U.S. Pat. No. 4,710,544 describes a melt processible thermoplastic composition comprising a blend of: 15-75 parts by weight of a crystalline polyolefin resin comprising polymerized monomer units of ethylene or propylene or mixtures thereof; and 25-85 parts by weight of a cross-linked ethylene/alkyl acrylate elastomer made from dynamically cross-linking an ethylene/alkyl acrylate/monoalkyl ester of 1,4-butenedioic acid copolymer containing about 60-90% by weight percent ethylene and wherein the alkyl group of the alkyl acrylate contains 1-6 carbon atoms, the dynamically cross-linked elastomer being dispersed throughout the crystalline polyolefin resin. Fillers added to this composition can range from 5-50 parts by weight of total polymers and processing oils and plasticizers can range from 10-100 parts by weight of total polymers.

U.S. Pat. No. 5,070,145 discloses polyamides reinforced by a blend of (i) a polyethylene or an ethylene/alkyl (meth)acrylate copolymer and (ii) an ethylene/alkyl (meth)acrylate/maleic anhydride copolymer.

EP-A-096,264 describes a material of high impact resistance containing: (A) a thermoplastic nylon having a relative viscosity of from 2.5 to 5, and (B) from 5 to 60% by weight, with respect to (A), of a non-crosslinked ternary copolymer consisting of: (a) 55 to 79.5% by weight of ethylene, (b) 20 to 40% by weight of at least one primary or secondary alkyl (meth) acrylate and (c) 0.5 to 8% by weight of a monomer having an acid function (e.g., maleic anhydride).

### SUMMARY OF THE INVENTION

The present invention provides an injectable thermoplastic composition comprising at least one tubular reactor-produced ethylene/alkyl-acrylate copolymer in combination with at least one low-density polyethylene. In some embodiments, the thermoplastic composition further contains a filler such as barium sulfate. In other embodiments, the thermoplastic composition additionally contains at least one plasticizer such as a processing oil.

### DETAILED DESCRIPTION OF THE INVENTION

The present invention relates to an injectable thermoplastic composition composed of a low density polyethylene blended with a tubular reactor-produced ethylene/alkyl (meth)acrylate, such as ethylene/methyl-acrylate (EMA) resin. It has now been found that a composition containing low density polyethylene and EMA can be used to produce a low cost, injection moldable grade of highly filled ethylene copolymer which exhibits new and unique properties, namely high tensile strength, high flex modulus, high temperature resistance and high tear strength while maintaining more than adequate elongation and a targeted specific gravity of about 2.0. The good elongation properties, specifically greater than two hundred percent, and high tensile strength are both a surprising and unexpected result of the combination of polyethylene and tubular reactor produced EMA.

The definitions herein apply to the terms as used throughout this specification, unless otherwise limited in specific instances. As used herein, the term “copolymer” refers to polymers containing two or more different monomers. The term “copolymer of various monomers” refers to a copolymer whose units are derived from the various monomers. The term “thermoplastic polymer” as used herein refers to a polymeric material that can be repeatedly softened by heating and hardened by cooling through a temperature range characteristic of the material and that in the softened state can be shaped into articles by flow, e.g, by molding or extrusion. The term “(meth)acrylic acid” means methacrylic acid and/or acrylic acid. Likewise, the term “(meth)acrylate” means methacrylate and/or acrylate. The term “melt index”, abbreviated “MI”, refers to the mass rate of flow of a polymer through a specified capillary under controlled conditions of temperature and pressure.

In the composition of the present invention, tubular reactor produced ethylene/alkyl (meth)acrylate copolymers are advantageously used over conventional autoclave batch-reactor-produced ethylene copolymers. Tubular reactor-produced copolymers have greater comonomer heterogeneity within the polymer (i.e., a more random monomer distribution along the chain length), less long chain branching, and higher melting point. As a consequence of the higher melting points of the tubular reactor-produced ethylene/alkyl (meth)acrylate copolymers, compositions containing them have higher heat resistance than compositions containing ethylene/alkyl (meth)acrylate copolymers produced in autoclave reactors.

Suitable alkyl groups include one to eight carbon atoms, with or without significant branching. The relative amount and choice of the alkyl group present in the alkyl (meth)acrylate ester comonomer play a role in establishing to what degree the resulting ethylene copolymer may be considered a polar polymeric constituent in the thermoplastic composition. Desirably, the alkyl group in the alkyl (meth)acrylate comonomer has from one to four carbon atoms and the alkyl (meth)acrylate comonomer has a concentration range of from 7 to 30 weight percent of the total tubular reactor-produced ethylene/alkyl (meth)acrylate copolymer. In one embodiment, the alkyl (meth)acrylate is methyl acrylate (viewed as the most polar comonomer) which is employed at a concentration range of from 18 to 30 weight percent of the total tubular reactor produced ethylene/methyl acrylate copolymer (e.g., EMA; 20-30% MA). In other embodiments, the alkyl (meth)acrylate is ethyl acrylate or butyl acrylate which can be used at an equal molar basis to suitable EMA copolymers.

Suitable tubular reactor produced ethylene/alkyl (meth)acrylate copolymers are commercially available under the tradename ELVALOY® AC from E.I. duPont de Nemours and Company, Wilmington, Del. (“DuPont”) and include, but art not limited to, EMA copolymer grades such as 1224 AC (2.0 MI), 1218 AC (2.0 MI), 1214 AC (2.0 MI) and 1125 AC (0.4 MI); EEA copolymer grades such as 2112 AC (1.0 MI) and 2615 AC (6.0 MI); and EnBA copolymer grades such as 3117 AC (1.5 MI) and 3217 AC (7.0 MI). These copolymers are particularly suitable as they exhibit a high filler acceptance.

Suitable tubular reactor-produced ethylene/methyl acrylate copolymers may have a melt index of up to about ten. In this melt index range, the suitable EMAs show significant improvement in both stiffness and elasticity, particularly relative to autoclave produced EMAs. As one of skill in the art can appreciate, the specific selection of the melt index grade of polymer component(s) to be used will be influenced by balancing the onset of improved elastic recovery associated with higher relative molecular weight EMA (such as ELVALOY® 1125 AC with a 0.7 MI) versus the ability of a relatively lower molecular EMA (such as ELVALOY® 1820 AC with an 8 MI) to more easily blend with fillers.

In general, a composition of the present invention contains about 1% to about 50% by weight of a tubular reactor-produced ethylene/alkyl (meth)acrylate copolymer. In some embodiments, the tubular reactor-produced ethylene/alkyl (meth)acrylate copolymer is about 10% to 30% by weight of the composition of the present invention. In particularly preferred embodiments, the tubular reactor-produced ethylene/alkyl (meth)acrylate copolymer is about 16% by weight of the composition of the present invention. Those of skill in the art are aware that compositions containing higher percentages of filler will by necessity contain lower percentages of ethylene/alkyl (meth)acrylate copolymer and low density polyethylene. For example, compositions having 76 weight % filler will contain less than about 24 weight % ethylene/alkyl (meth)acrylate copolymer and low density polyethylene.

It is further contemplated that a mixture of two or more ethylene/alkyl (meth)acrylate copolymers may be used in the compositions of the present invention in place of a single copolymer, provided that the average values of the comonomer content are within the ranges indicated above.

The manufacturing of the tubular reactor EMA, as previously stated, is generally in a high pressure tubular reactor at elevated temperature with additional introduction of reactant comonomer along the tube and not merely manufactured in a stirred high-temperature and high-pressure autoclave type reactor. However, as one of skill can appreciate, similar ethylene/alkyl (meth)acrylate material can be produced in a series of autoclave reactors wherein comonomer replacement is achieved by multiple zone introduction of reactant comonomer, as described in U.S. Pat. Nos. 3,350,372; 3,756,996; and 5,532,066. These high melting point materials may provide performance benefits similar to those of tubular reactor produced ethylene/alkyl (meth)acrylate copolymers, and, if so, are considered to be within the scope of the invention.

As demonstrated herein, the inclusion of a low density polyethylene (e.g., a density of 0.910 to 0.935 g/cc) into a thermoplastic composition containing an ethylene/alkyl (meth)acrylate copolymer advantageously increases the melt point temperature, tensile strength and flex modulus of the thermoplastic composition. In general, a composition of the present invention contains about 1% to about 20% by weight of a low density polyethylene. In some embodiments, the low density polyethylene is about 10% to 30% by weight of the composition. In particularly preferred embodiments, the low density polyethylene is about 10% by weight of the composition of the present invention.

A low density polyethylene prepared by polymerizing ethylene at high pressure (e.g., up to 45,000 psi) and high temperature (e.g., 180 to 190° C.) is particularly suitable for use in the composition of the present invention. A low density polyethylene produced in such a manner (e.g., via autoclave) typically has a branched structure, an MI of about 4.5, a density of about 0.923 g/cc and relatively low crystallinity. Alternatively, a linear low density polyethylene having a density similar to that of an autoclave-produced low density polyethylene (i.e., 0.95 to 0.930 g/cc) can be synthesized through a variety of other processes such as gas phase, solution, slurry, or tubular reactor in the presence or absence of a catalyst.

While low density polyethylene has a high level of long-chain branching, linear low density polyethylene has high levels of short-chain branching. As a result, autoclaved-produced low density polyethylene contributes to flexible and soft end-products whereas linear low density polyethylene displays better tear and impact film properties. Accordingly, it is contemplated that a low density polyethylene utilized in the composition of the present invention can be a low density polyethylene or linear low density polyethylene, or a combination thereof, depending on the desired characteristics of the end-product.

To modify the density of the thermoplastic composition of the present invention, one or more fillers may optionally be added. Examples of suitable fillers include, but are not limited to, calcium carbonates of natural or synthetic origin, magnesium carbonate, zinc carbonate, mixed salts of magnesium and calcium such as dolomites, limestone, magnesia, barium sulfate, calcium sulfate, magnesium and aluminum hydroxides, silica, wollastonite, clays and other silica-alumina compounds such as kaolins, silico-magnesia compounds such as talc, mica, solid or hollow glass beads, metallic oxides such as zinc oxide, iron oxides, titanium oxide, or mixtures thereof. Preferred fillers include barium sulfate (60 lbs/cu. ft) and calcium carbonate (44 lbs/cu. ft). Barium sulfate is particularly preferred.

The amount of filler(s) that should be included in the composition of the present invention is primarily a function of the density of the filler(s). Particle size and shape of the filler(s) also will have an effect on properties of blends. Fine particle size fillers generally have a tendency to result in higher blend viscosities and are generally more expensive. With these provisos, the amount of filler added to a thermoplastic composition of the present invention may range from about 40% to about 90% by weight, or from about 50% to about 80% by weight. When using a filler of medium density, such as calcium carbonate, the amount of filler may range from about 50% to about 85% by weight, alternatively from about 65% to about 85% by weight, and when using a filler of higher density, such as barium sulfate, the amount of filler is from about 65 to about 90% by weight. In a particularly preferred embodiment, barium sulfate is added in an amount of about 70% by weight, based on the total weight of the thermoplastic composition.

A filled thermoplastic composition of the present invention can further contain one or more additives to obtain some desired effect, such as reduction of cost, or enhancement of a physical property. Accordingly, suitable processing aids, such as oils, monomeric organic acids, such as stearic acid or a metal salt thereof; stabilizers such as antioxidants, ultraviolet ray absorbers, and hydrolytic stabilizers; plasticizers; tackifiers, such as known hydrocarbon tackifiers; waxes, such as polyethylene waxes; crosslinking agents, such as peroxides or silanes; colorants or pigments (e.g., carbon black); optical brighteners; surfactants; anti-static agents; fire-retardants; lubricants; reinforcing agents such as glass fiber and flakes; antiblock agents; release agents; and/or mixtures thereof can be added to the extent that they do not interfere with desired physical properties of the thermoplastic composition of the invention. The additives are employed in functionally equivalent amounts known to those skilled in the art, generally in amounts of up to about 30%, or from about 0.01% to about 5%, or in particular from about 0.02% to about 3% percent by weight, based upon the total weight of the filled thermoplastic composition.

Plasticizer ingredients useful in the composition of the present invention are generally known as process oils or processing oils. Three types of processing oils include the paraffinic, aromatic and naphthenic types. Typically, these oils are not pure and the grades identify the major oil type present. Paraffinic oils tend to “bleed” from blends; however, this could be useful in specialty application, e.g., in concrete forms where mold release characteristics are valued. Naphthenic and aromatic oils are nonbleeding when used in proper ratios and are thus desirable for uses such as automotive carpet backings. Processing oils are also subdivided by viscosity range. Thin oils may have a viscosity as low as 100-500 SUS (Saybolt Universal Seconds) at 100° F. (38° C.). Heavy oils may have a viscosity as high as 6000 SUS at 100° F. (38° C.). Processing oils, especially naphthenic and aromatic oils with viscosity of from about 100 to 6000 SUS, are generally desirable.

Other groups of plasticizers that are useful in the composition of the present invention are the epoxidized oils (e.g., epoxidized soybean oil and epoxidized linseed oil) and the polyesters, which, in general, are liquid condensation products of a polybasic acid and a polyol.

Mixtures of polyesters with hydrocarbon oils are also effective plasticizers in the present invention. One objective of using such a mixture is to couple the high efficiency of the relatively high cost polyester with the low cost of the hydrocarbon oil. The cost and performance of a compound plasticized with such a mixture can be improved significantly for a given application because properties can be tailored more precisely, or filler levels can be increased.

Polyethers and polyether esters are also useful as plasticizers in blends of the ethylene copolymers and fillers described herein. In general, polyether plasticizers are oligomers or low molecular weight polymers of alkylene oxides; polymers of ethylene or propylene oxide are the most common types available commercially. Desirably, polyethers for use in the practice of this invention are those consisting of the polyols based on random and/or block copolymers of ethylene oxides and propylene oxides. The copolymer polyols provide better performance in terms of efficiency in thermoplastics of the present invention containing very high levels of filler.

Mixtures of the polyether or the polyether ester plasticizers with either a polyester plasticizer or a hydrocarbon processing oil can also be used in the practice of this invention. One advantage of a polyether/polyester combination is economic, resulting from the relatively low price of polyethers with respect to polyesters. Combinations of polyether and processing oil are also more economical, because of the lower cost of the oil.

The relative proportions of the two components in a combination of polyether and polyester can be adjusted according to the efficiency of the system based on property requirements and cost. Those based primarily on polyester will not be as stiff and will be more expensive, for example, than those based primarily on a polyether or polyether ester.

As referred to above, a mixture of processing oil, on the one hand, and epoxidized oil, polyester or polyether or polyether ester, or any combination thereof, on the other hand, can also be used as the plasticizer for the compositions of the present invention.

In general, the amount of plasticizer present in a composition of the present invention may be in the range of from about 1% to about 20% by weight, or from about 2% to about 15% by weight. When using a filler of medium density, such as calcium carbonate, the amount of plasticizer is generally from about 4% to 10% by weight and when using a filler of higher density, such as barium sulfate, the amount of plasticizer is typically from about 3% to about 10% by weight, based on the total weight of the thermoplastic composition.

In some cases, addition of processing oil in an amount of less than about 2% will not have a significant effect. Processing oil in excess of about 10% can cause the melt index to rise rapidly and the blend to become much softer. At extremes, for example, at 70% filler, over 15% oil and less than 15% ethylene/alkyl-acrylate, the oil content overwhelms the blend as the amount of ethylene/alkyl-acrylate present does not provide adequate strength for the blend.

In accordance with the teachings provided herein, an exemplary highly-filled thermoplastic composition containing a low density polyethylene and ethylene/methyl-acrylate was produced. This exemplary composition was found to have a very high mean tensile strength (ranging from 500 to 600 psi), a high temperature resistance (a melting temperature above 100° C.), a high flex modulus (greater than 12000 psi), a high tear strength (greater than 150 lbf/in), a more than adequate elongation (having a mean break elongation of greater than 200%), and a specific gravity of more than 2.0.

The teachings herein provide several different polymeric ingredients and their individual contribution to a thermoplastic composition of the present invention. However, as will be apparent to one of skill in the art, polymeric ingredients of the above types can be further formulated. For example, the compounder can elect to modify a simple four-component composition (e.g., a tubular reactor-produced EMA/a polyethylene/a filler/a plasticizer) by replacing a part of the tubular reactor produced EMA with a small amount of a tackifier for adhesivity. In addition part of an oil can be replaced with a polyester or polyether-type additive to attain highly effective plasticization with a lower total amount of plasticizer. Thus, there are many possible combinations and permutations available to the skilled compounder, while remaining within the spirit and intent of this invention.

The blends of the present invention are generally not covalently cross-linked or cured, unless desired during end-product production. Further, these blends are thermoplastic in nature and therefore can be recycled after processing. The recycled material can also contain textile fibers, jute, etc. that may be present in the trim obtained during production of the finished product (e.g., automotive carpet backing).

A commercially sized batch-type Banbury or equivalent intensive mixer is suitable for preparing the compositions of the present invention. A Farrel continuous mixer (“FCM”) is also a suitable mixing device. In either instance, dry ingredients are charged in routine fashion. When employed, it is convenient in most cases to inject the plasticizer component directly into the mixing chamber as per widely used practice with either of these types of equipment. When more than one plasticizer is used, and where any one of the plasticizers is present in a small amount (less than about 10 weight percent of the total plasticizer mixture), the plasticizers are preferably blended before addition to the other ingredients used in the filled compositions. This will facilitate uniform distribution of each plasticizer component in the final composition and thus ensure that optimum properties are obtained. If desired, the copolymers and the plasticizer(s) can be precompounded as a pellet blend or as a masterbatch in a suitable intensive mixing device (e.g., Banbury mixer or screw extruder). This masterbatch can then be compounded with the filler and the other remaining ingredients to produce the final composition. A mix cycle of about 3 minutes is generally adequate for the Banbury mixer at an operating temperature ranging typically from about 325° F. to about 375° F. The operating rate for the FCM unit generally will fall within ranges predicted by literature prepared by the Farrel Company of Ansonia, Conn. Here, temperatures ranging from about 325° F. to about 425° F. are typically effective. When processing on any type of equipment, a very low plasticizer level, for example about 2 to 3%, may require higher temperatures, while plasticizer levels above about 7% may mix well at lower mixer temperatures. While not evaluated, it is expected that other devices for handling viscous mixes (MI of 0.1 to 20) should perform in an entirely satisfactory manner.

Once the thermoplastic composition of the invention is blended, routine commercial practices can be used, such as underwater melt-cutting plus drying or use of sheeting plus chopping methods, to produce a final composition in pellet form. Alternately, the hot mixture also can be immediately fabricated into a final form, e.g. sheeting, molding, extrusion, casting, etc.

The highly-filled compositions described herein can be processed industrially into final sheet, film or three-dimensional solid form by using standard fabricating methods well known to those skilled in the art. Thus, fabricating methods such as extrusion, calendering, injection or rotomolding, extrusion coating, sheet laminating, sheet thermoforming, etc. are all practical means for forming the compositions of this invention.

The blends of the present invention can readily be extruded onto a substrate, such as automotive carpet, foam, fabric or scrim material, or can be extruded or calendered as unsupported film or sheet according to standard methods. Depending upon the equipment used, and the compounding techniques employed, it is possible to extrude a wide range of film thickness, from below 20 mils to above 100 mils.

In view of the improved characteristics of the thermoplastic composition of the present invention (e.g., high tensile strength, high flex modulus, high temperature resistance, high tear strength, adequate elongation, and a specific gravity of about 2.0), this composition will be useful in the sheeting field, particularly for low cost, dense, sound-deadening structures. A moldable sound barrier can be used in sound deadening applications including transport systems such as automobiles, motorcycles, buses, tractors, trains, trams, airplanes, and the like. When applied to automotive carpet, blends described herein are an effective and economic means to deaden sound, while also simultaneously serving as a moldable support for the carpet. The application of the compositions of the present invention in carpets, and particularly in automotive carpets, is essentially identical to methods already described in U.S. Pat. No. 4,191,798.

When used in sheet form, especially when coated onto a fabric, the blends can be installed in other areas of an automobile, truck, bus, etc., such as side panels, door panels, roofing areas, headliners and dash insulators. The compositions of this invention may also be used in automotive door and truck liners, rear seat strainers, wheel well covers, carpet underlayments, dash mats, sound damped automotive enclosures such as oil pans, disc brake pads, mufflers, etc.

In sheet form, the highly-filled blends can also be used as drapes or hangings to shield or to surround a noisy piece of factory equipment such as a loom, a forging press, conveyor belts and material transfer systems, etc.

The compositions of this invention can further be used for sound deadening in small and large appliances, including dishwashers, refrigerators, air conditioners, and the like; household items such as blender housings, power tools, vacuum cleaning machines, and the like; lawn and garden items such as leaf blowers, snow blowers, lawn mowers, and the like; small engines used in boating applications such as outboard motors, water-jet personal watercraft, and the like. Additional applications include devices for modifying the sound of a drum, loudspeaker systems, acoustically damped disc drive systems, and the like.

In construction and building industries, compositions of this invention can be used as wallpapers/coverings, composite sound walls, thermoformable acoustical mat compositions, vibration-damping constrained-layer constructions, and sound insulation moldable carpets. In laminated sheet form, the blends, faced with another material, can be used to achieve both a decorative and a functional use, such as dividing panels in an open-format office. An advantage of the blends of this invention is that certain physical properties, such as flexibility and toughness, which are typically reduced when fillers are added to polymers, can be maintained within useful limits over a broad range of filler concentrations. As noted above, the improved heat resistance and better thermal stability afforded by the tubular reactor produced ethylene/alkyl-acrylate copolymer is particularly advantageous. Thus, blends of this invention could be used in the manufacture of wire and cable components in a variety of electronic, telecommunications and similar areas, of various molded parts, of sealants and caulks, or in other uses where flexibility, toughness and heat resistance and better thermal stability are desired, coupled with the economies normally achieved by the incorporation of low cost fillers.

The following Example is presented to more fully demonstrate and further illustrate various aspects and features of the present invention. As such, the Example is not intended to limit the scope of the invention in any way.

### EXAMPLE 1

### Polyethylene-Containing Thermoplastics

Methods.

Ingredients used in the following example were mixed according to standard methods disclosed herein. All parts and percentages are by weight unless otherwise specified. Mix conditions used were fluxing for 3 minutes, at a temperature ranging from about 325° F. to about 375° F. (from about 160° C. to about 190° C.).

Melt index (MI) was measured in accord with ASTM D-1238, condition E, at 190° C., using a 2160 gram weight, with values of MI reported in grams/10 minutes. Density was determined in accord with ASTM D-792. Differential scanning calorimetry (DSC) melting point (m.p.) was determined in accord with ASTM D-3418. Vicat softening point was determined in accord with ASTM D-1525. Shore A hardness was determined in accord with ASTM D-2240.

Materials.

EMA1: Tubular reactor-produced ethylene/24% methyl acrylate copolymer (ELVALOY® 1224AC) having a MI of 2.0 g/10 minutes, density of 944 kg/m³, melting point of 91° C. and Vicat softening point of 48° C.

EMA2: Tubular reactor-produced ethylene/20% methyl acrylate copolymer having MI of 8.0, density of 942 kg/m³, melting point of 92° C. and Vicat softening point of 54° C.

Autoclave-produced low density polyethylene (DPE1640) having a MI of 4.5 g/10 minutes and density of 0.923 gm/cc.

Stearic acid (octadecanoic acid, CH₃(CH₂)₁₆—COOH), molecular weight of 284.49, density 0.94 g/cm³, melting point of 70° C., commercial grade available under the trade name Industrene™ B from the Chemtura Corporation of Middlebury, Conn. (formerly the Crompton Corporation).

D3000 oil, a naphthenic processing oil having Saybolt Universal Seconds (SUS) Viscosity at 210° F.=128, flash point=510° F., initial boiling point=830° F. and Ford fog Value=80%, available from Ergon, Inc. of Jackson, Miss.

BLK CON, carbon black dispersed in polyethylene, used as a colorant, available under the tradename PolyOne™ 2447 from the PolyOne Corporation of Avon Lake, Ohio.

Barium sulfate, filler, molecular weight of 233.39, density 60 lbs/cu. ft, decomposition temperature of about 1600° C., commercial grade.

Table 1 lists the ingredients and proportions (in % by weight) thereof used for comparative analysis of compositions containing (KEL 1072) or lacking (Control) a low density polyethylene.

TABLE 1

| Ingredient | Control | KEL1072 |
|---|---|---|
| EMA1 | 14.30 | 16.25 |
| EMA2 | 10.00 | — |
| Low Density Polyethylene | — | 10.00 |
| Stearic Acid | 0.60 | 0.35 |
| D3000 Oil | 4.70 | 3.00 |
| BLK CON | 0.40 | 0.40 |
| Barium Sulfate | 70.00 | 70.00 |

The data in Table 2 demonstrate that the addition of a low density polyethylene to an ethylene/alkyl-acrylate copolymer improves many of the physical properties of the ethylene/alkyl-acrylate copolymer. For example, a blend composed of EMA1 and EMA2 (Control) lacked stiffness compared to the KEL1072. The KEL1072 exhibited increased heat resistance, tensile strength, melt point temperature, and flex modulus compared to the control, while maintaining a high tear strength and good elongation at break. Results presented as Exp. B for KEL1072 was carried out after aging for 40 hours in 50% relative humidity at 21° C. The flex modulus rise exhibited by KEL1072 after the condition period is believed to be due to increased crystallinity of the formulation.

TABLE 2

KEL1072

| Property | Control | Exp. A | Exp. B |
|---|---|---|---|
| Mean Break Elongation (%) | 447 | 255 | 275 |
| Mean Tensile Strength | 362 | 552 | 543 |
| (psi) | | | |
| DSC Melt (° C.) | 86.8 | 108 | 108 |
| Melt Index | 8.2 | 3.8 | 3.8 |
| Shore A | 82 | 90 | 90 |
| Flex Modulus (psi) | 6643 | 12796 | 14855 |
| Specific Gravity | 2.04 | 2.02 | 2.02 |
| Tear Strength (lbf/in) | N/A | 163 | 152 |

Having thus described and exemplified the invention with a certain degree of particularity, it should be appreciated that the following claims are not to be so limited but are to be afforded a scope commensurate with the wording of each element of the claim and equivalents thereof.

What is claimed is:

1. A thermoplastic composition comprising at least one tubular reactor-produced ethylene/alkyl (meth)acrylate copolymer and at least one low-density polyethylene.

2. The thermoplastic composition of claim 1, wherein the alkyl group in said alkyl (meth)acrylate comprises from one to four carbon atoms.

3. The thermoplastic composition of claim 1, wherein said tubular reactor-produced ethylene/alkyl (meth)acrylate copolymer comprises an ethylene/methyl acrylate copolymer.

4. The thermoplastic composition of claim 1, further comprising a filler.

5. The thermoplastic composition of claim 4, wherein the filler comprises barium sulfate.

6. The thermoplastic composition of claim 4, comprising from about 40% to about 90% by weight of the filler.

7. The thermoplastic composition of claim 1, further comprising at least one plasticizer.

8. The thermoplastic composition of claim 7, wherein the plasticizer comprises a processing oil.

9. An article comprising the thermoplastic composition of claim 1.

10. The article of claim 9, wherein a sound-deadening structure comprises the thermoplastic composition.

11. The article of claim 10, wherein the sound-deadening structure comprises a carpet having a backing, and the backing of the carpet is at least partially coated with the thermoplastic composition of claim 1.

12. The article of claim 10, wherein the sound-deadening structure comprises a sheet, a drape, or a hanging.

13. The article of claim 12, wherein the sheet is coated onto a fabric.

14. A vehicle wherein a side panel, a door, a door panel, a truck liner, a rear seat strainer, a wheel well cover, a carpet underlayment, a dash mat, an oil pan, a disc brake pad, a mufflers, a roofing area, a headliner or a dash insulator comprises an article of claim 12.

15. The article of claim 10, selected from the group consisting of a dishwasher, a refrigerator, an air conditioners, a blender housing, a power tool, a vacuum cleaning machine, a leaf blower, a snow blower, a lawn mower, a small engines, a device for modifying the sound of a drum, a loudspeaker system, or an acoustically damped disc drive system, a wallpaper, a wall covering, a composite sound wall, a thermoformable acoustical mat, a vibration-damping constrained-layer construction, a sound insulation moldable carpets, a dividing panel for an open-format office, a wire or cable, a molded part, a sealant and a caulk.

16. The article of claim 9, being a sheet or a film.

17. The article of claim 9, wherein the composition is extruded onto a substrate.

18. The article of claim 17, wherein the substrate is selected from the group consisting of carpet, foam, fabric and scrim material.
